(19) United States
(12) Patent Application Publication
(10) Pub. No.: US 2004/0107036 A1
(43) Pub. Date: Jun. 3, 2004

(54) Tire and system

(76) Inventor: Daniel E. Hicks, Easley, SC (US)

Correspondence Address: Alan A. Csontos, Michelin North America, Inc., P.O. Box 2026, Greenville, SC, 29602, US

(21) Appl. No.: 10/654,411

(22) Filed: Sep. 3, 2003

Related U.S. Application Data
(60) Provisional application No. 60/407,921, filed on Sep. 3, 2002.

(51) Int. Cl. G05D 1/00

(52) U.S. Cl. 701/93; 340/442

(57) ABSTRACT

The present invention is a speed limiting system for a vehicle comprising: a sensor for detecting tire failure; a signal generator to transmit a signal indicating tire failure; a speed limiter for controlling vehicle speed that receives said signal, and limits vehicle speed according to a selected speed profile which goes from an initial higher speed to a lower speed.

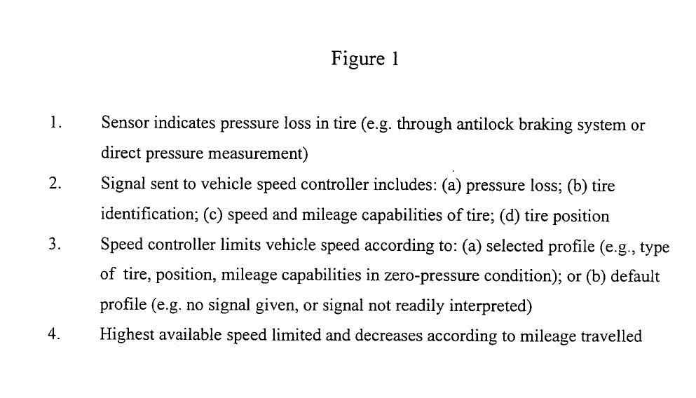

In one embodiment of the invention, the tire failure is sudden loss of tire pressure.

### FIELD OF THE INVENTION

The present invention is in the field of tires, and more specifically, in the field of pneumatic tires that function with or without inflation pressure.

### BACKGROUND OF THE INVENTION

There is an ongoing effort by automobile manufacturers to eliminate the spare tire in order to reduce vehicle curb weight, increase available space within the vehicle, and provide operator convenience. This is particularly true for vehicles having higher comfort specifications, such as conventional luxury, family or urban-economy-type vehicles. This is even true for the sports utility vehicle, and for the new generation of electrical and hybrid-type vehicles which have critical space and weight restrictions.

Furthermore, with increased travel on multi-lane high-speed highways, even if a vehicle with a flat can be maneuvered to the roadside, changing a flat can be hazardous.

Thus, the capability to readily reach the next exit is highly desirable should a flat occur.

One solution is the recently introduced “runflat” tire. This is a pneumatic tire that functions for a certain period to support a vehicle even after inflation pressure has been lost. This tire reduces the need for a spare tire and ancillary equipment. Therefore, in some cases it may achieve substantial savings in vehicle weight, and increase the space for other automotive systems and cargo. Numerous variations of runflat tires have been developed. Most involve a thickened sidewall which supports the tire in the uninflated condition.

Another effort has been the use of a combined tire, wheel and annular support assembly. U.S. Pat. Nos. 5,891,279; 5,749,982 and 5,634,993, all assigned to Compagnie Generale Des Etablissements Michelin-Michelin & Cie (France), disclose such an assembly.

However, both approaches are limited in the distance a vehicle can travel with a tire in the uninflated condition, and the proper speed at which a vehicle should travel. Therefore there is a need for an improved pneumatic tire system that functions without inflation pressure.

### SUMMARY OF THE INVENTION

The present invention is a speed limiting system for a vehicle comprising: a sensor for detecting tire failure; a signal generator to transmit a signal indicating tire failure; a speed limiter for controlling vehicle speed that receives said signal, and limits vehicle speed according to a selected speed profile which goes from an initial higher speed to a lower speed.

In one embodiment of the invention, the tire failure is sudden loss of tire pressure.

### DETAILED DESCRIPTION OF THE INVENTION

The present invention is a speed limiting system for a vehicle comprising: a sensor for detecting tire failure; a signal generator to transmit a signal indicating tire failure; a speed limiter for controlling vehicle speed that receives said signal, and limits vehicle speed according to a selected speed profile which goes from an initial higher speed to a lower speed.

In one embodiment of the invention, the tire failure is sudden loss of tire pressure.

The majority of pneumatic tire systems that function without inflation pressure fall into two types: those with thickened sidewalls, and those with annular inserts fitting around the rim of the wheel, where the annular insert is inside the cavity of the tire. Both systems have improved markedly in recent years. However, both are intended only for temporary use: after a certain number of miles the uninflated tire must be changed. Both systems are generally intended for operation at a lower speed in the uninflated condition than in the inflated condition.

Both the annular insert system and the thickened sidewall system generate significant heat during uninflated operation of the tire. The heat is generated through greater flexion of the tire in the uninflated condition, and, in the case of the annular insert, friction between the inside of the tire and the outer circumference of the annular insert. This heat can hasten degradation of the tire, and hasten degradation of the annular insert. In addition, improvements in both systems have made vehicles more comfortable to drive with a tire in the uninflated condition. In some instances, a vehicle may be more comfortable to drive in the uninflated condition the faster it is driven. A driver may therefore unintentionally operate at a speed inconsistent with prolonging the integrity of the tire or the annular insert therein. The present invention may also provide for operation of the vehicle at lower speed in order to minimize damage to the rim of the wheel or the components of the vehicle suspension system.

In the system according to the present invention, a sensor detects one or more conditions indicating tire failure, including tire inflation pressure, temperature, noise, vibration, and rolling diameter of the tire. The sensor might directly monitor the condition, i.e., directly sense the tire inflation pressure, or it might indirectly sense tire inflation pressure, through comparison of inputs from a vehicle anti-lock braking system. A signal generator then transmits a signal to what is termed here the vehicle speed limiter, which may be a microprocessor-controlled system in the vehicle engine. The signal can be transmitted by a number of means, including, but not limited to electrical and electromagnetic transmission. The system according to the present invention then selects the appropriate tapering speed profile, one that maximizes the longevity of the uninflated tire, and is most consistent with safe-handling of the vehicle. By tapering, it is meant that the profile starts at a higher initial speed, but then slopes downward according to distance of operation of the vehicle in the uninflated condition. For example, immediately after loss of inflation pressure, the profile may allow operation of the vehicle at a maximum speed of fifty miles per hour. If the vehicle is driven for thirty miles, the profile might gradually limit the maximum speed to forty miles per hour, and downward still, the greater the number of miles travelled. The profile might adjust according to inputs such as temperature of the tire (if the tire includes a temperature sensor), time travelled at very low speeds, or times the vehicle is at complete rest, allowing cooling of the tire.

The profile is selected according to identifying information in the signal. This identifying information can include specific mileage and speed (and even temperature) capabilities of the tire (including the insert), and position of the tire on the vehicle. A tire on the front of a vehicle supporting the weight of an engine might prompt a profile with a lower initial top speed that declines more quickly than that for the same tire mounted on the rear of the vehicle.

If no signal, or an unreadable signal is received, the system according to the present invention would select a default tapering speed profile.

Table 1 illustrates a sequence of activation of the system according to the present invention.

While a preferred embodiment of the invention has been described using specific terms, such description is for illustrative purposes only, and it is to be understood that changes and variations may be made without departing from the spirit or scope of the invention.

TABLE 1

| | |
|---|---|
| 1. | Sensor indicates pressure loss in tire |
| | (e.g. through antilock braking system or |
| | direct pressure measurement) |
| 2. | Signal sent to vehicle speed controller includes: |
| | (a) pressure loss; (b) tire |
| | identification; (c) speed and mileage capabilities of tire; |
| | (d) tire position |
| 3. | Speed controller limits vehicle speed according to: |
| | (a) selected profile (e.g., type |
| | of tire, position, mileage capabilities in |
| | zero-pressure condition); or (b) default |
| | profile (e.g. no signal given, or signal not |
| | readily interpreted) |
| 4. | Highest available speed limited and decreases |
| | according to mileage travelled |

I claim:

1. A speed limiting system for a vehicle comprising:
(a) sensor for detecting tire failure;
(b) signal generator to transmit a signal indicating tire failure;
(c) speed limiter for controlling vehicle speed to receive said signal, and limit vehicle speed according to;
(d) a selected speed profile which goes from an initial higher speed to a lower speed.

2. The system of claim 1, wherein the sensor detects conditions selected from the group consisting of: tire inflation pressure, temperature, noise, vibration, and rolling diameter of the tire.

3. The system of claim 2, wherein the sensor is a tire pressure sensor.

4. The system of claim 3, wherein the sensor is selected from the group consisting of: (a) a sensor for directly measuring tire pressure; and (b) a sensor for indirectly measuring tire pressure through the anti-lock braking system.

5. The system of claim 1, wherein the profile is selected from the group consisting of:
(a) profile for a pneumatic tire including an annular insert intended to support said tire in the event of pressure loss;
(b) profile for a pneumatic tire including a thickened sidewall intended to support said tire in the event of pressure loss; and
(c) a default profile.

6. The system of claim 1, wherein the signal includes information identifying specific mileage and speed capabilities of the tire.

7. The system of claim 1, wherein the signal includes information on the position of the tire on the vehicle.
